(19) United States
(12) Patent Application Publication
(10) Pub. No.: US 2015/0124341 A1
(43) Pub. Date: May 7, 2015

(54) MACRO CONVERSION LENS

(71) Applicant: NAUTICAM INTERNATIONAL LIMITED, Fo Tan (HK)

(72) Inventor: YUK SHING LAI, NEW TERRITORIES (HK)

(21) Appl. No.: 14/534,225

(22) Filed: Nov. 6, 2014

Related U.S. Application Data
(60) Provisional application No. 61/900,498, filed on Nov. 6, 2013.

(51) Int. Cl. G03B 17/14; G03B 17/08; G02B 7/14

(52) U.S. Cl. CPC G03B 17/14; G02B 7/14; G03B 17/08
USPC 359/784

(57) ABSTRACT

Disclosed is a conversion lens including a sequential assembly of lens elements. The first lens element has a positive refractive power, the second lens element and the third lens element, the second and third lens elements each having a surface convex with respect to the first lens element. The characteristics of at least one lens element are selected to compensate for the use of the conversion lens in water. Desirably the first lens element includes a first part having a negative meniscus lens and a second part forming a bi-convex lens.

### TECHNICAL FIELD OF THE INVENTION

This invention relates to a macro conversion lens for use with a land macro lens to increase magnification of the image. The conversion lens of the invention is intended for use underwater.

### BACKGROUND OF INVENTION

Macro photography relates to close-up photography, where the object being photographed is very small and the image produced of the object usually equals life size. Such photography is a popular form of underwater photography.

A waterproof lens port which is able to be connected to an underwater camera housing is commonly adopted to accommodate a land macro lens for underwater use. The front part of the lens port usually contains a glass window. The lens port is attached to the waterproof underwater housing, within which the camera body is housed. The connection between the underwater lens port and the housing is made waterproof via an O-ring.

Waterproof lenses designed to be put in front of the glass window of the lens port exist with a view to increase the magnification of the image. These normally contain an external thread which screws onto an internal thread in front of the glass window of the port. Users can attach and detach such a lens from the port underwater to suit the object being photographed and the magnification desired. The volume between the rear element of such a lens and the glass window of the port is hence filled with seawater. Such an arrangement is shown in FIG. 1.

Prior existing lenses of this kind consist of a simple magnification lens, i.e. a positive bi-convex element (FIG. 1), or an achromatic doublet (FIG. 2), these arrangements are most commonly used in magnifying glasses on land; the achromatic doublet consists of a positive bi-convex element and a negative element cemented together, this gives better optical performance by counterbalancing the chromatic and spherical aberrations.

However, since these lenses are designed to be used on land, the higher refractive index of seawater, compared to air, has not been taken into account; this leads to a reduction of optical performance when the lenses are used underwater. Also, by having a convex front water contacting lens element, the photographing angle of field is increased, leading to a reduction in magnification.

The example in FIG. 3 above uses two flat glass elements as the front and rear elements to maintain the magnification as it would be on land and a doublet lens between them. However, like the earlier examples, the refractive index of seawater has not been taken into account, hence there is no improvement of the overall optical performance of the lens.

Another disadvantage of the prior lenses is that the focal length of the lens decreases with the magnification which means it is necessary to get very close to the object if a large magnification is desired. This is sometimes impossible underwater as for instance, it may scare the object away; it is also desirable to have ample distance between the camera and the object for underwater strobe placement, allowing more creative lighting effect.

### Prior References:

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art in any country.

Definitions:

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### OBJECT OF THE INVENTION

It is an object of the invention to provide a conversion lens that ameliorates some of the disadvantages and limitations of the known art or which will at least provide the public with a useful choice.

It is a further object of the invention to provide an underwater macro convertor, for use with land macro lenses.

### DISCLOSURE OF THE INVENTION

In a first aspect the invention resides in a macro conversion lens including a sequential assembly of lens elements, the sequence comprising a first lens element, a second lens element and a third lens element, each lens element being substantially co-axial and the second lens element comprising a meniscus lens convex with respect to the first lens.

Preferably the first lens element has a positive refractive power.

Preferably third lens element has a surface convex with respect to the first lens element.

Preferably the characteristics of at least one lens element is selected to compensate for the use of the conversion lens in water.

Preferably, the first lens element comprises a first part being a meniscus lens and a second part being a bi-convex lens.

Preferably the meniscus lens is a negative meniscus lens.

Preferably the first part and second part of the first lens element comprise a cemented lens element.

In a further aspect the invention resides in a conversion lens according to any one of the preceding paragraphs when mounted on an underwater lens port.

### BRIEF DESCRIPTION OF DRAWINGS

The invention will now be described, by way of example only, by reference to the accompanying drawings in which:

FIG. 1 is a diagrammatic representation of a first prior art macro conversion lens,

FIG. 2 is a diagrammatic representation of a second prior art macro conversion lens,

FIG. 3 is a diagrammatic representation of a third prior art macro conversion lens,

FIG. 4 is a diagrammatic representation of the basic construction of a macro conversion lens according to the invention, and

FIGS. 5 to 8 are diagrammatic representations of four selected versions of macro conversion lenses according to the invention.

### BEST MODE FOR CARRYING OUT THE INVENTION

The following description will describe the invention in relation to preferred embodiments of the invention, namely a macro conversion lens. The invention is in no way limited to these preferred embodiments as they are purely to exemplify the invention only and that possible variations and modifications would be readily apparent without departing from the scope of the invention.

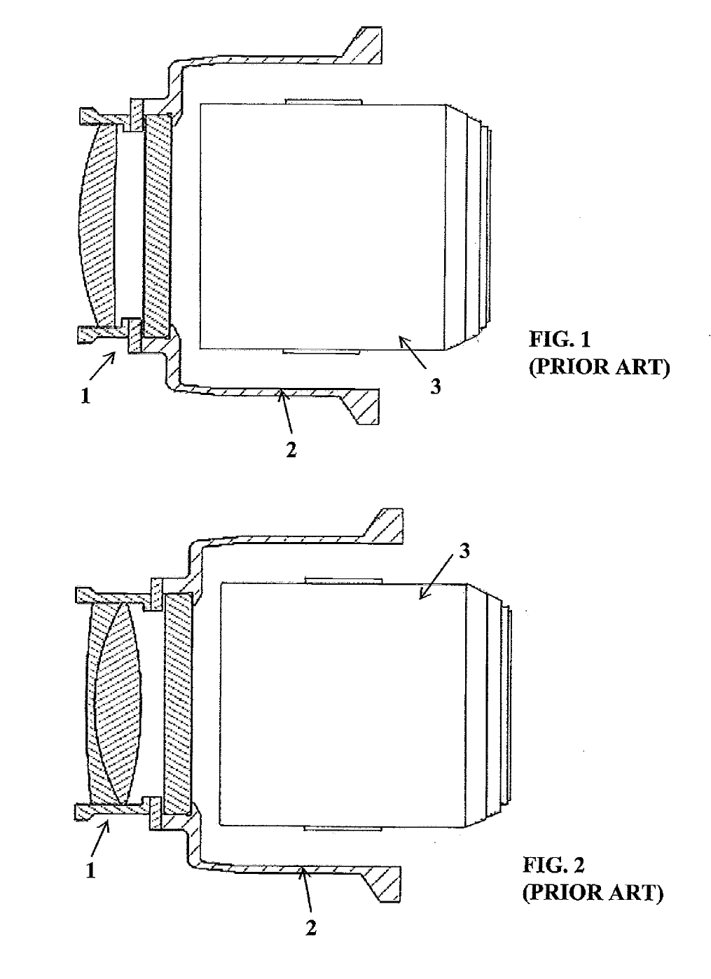

FIG. 1 shows a prior art macro conversion lens 1 as above described positioned on an underwater lens port 2. The lens port is connectable to an underwater camera housing (not shown). The connection is waterproof, for example, in the known manner. The conversion lens is connected to the lens port, for example, by a screw thread as above described. The camera lens 3 is positioned in use within the lens port 2.

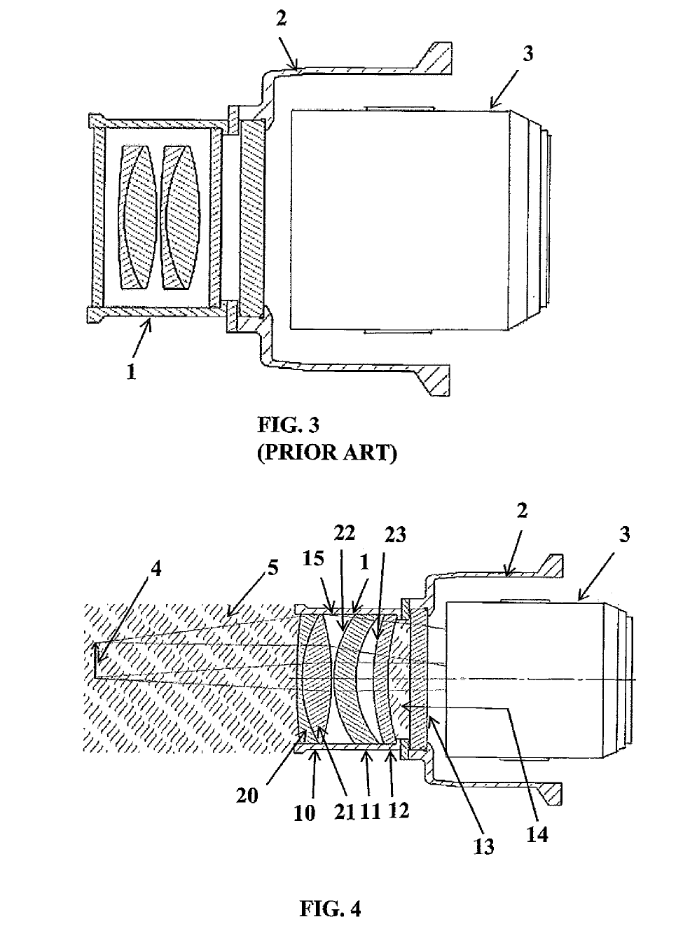

FIG. 2 shows a further prior art macro conversion lens 1 as above described where the lens 1 is a compound lens with the two lens elements in contact, and FIG. 3 shows the third prior art macro conversion lens above described.

Referring now to FIG. 4, the lens port 2 and camera lens 3 are provided as above, the lens port 2 being connected in waterproof fashion, in use, to an underwater camera housing, for example, in the known manner. Known techniques of waterproofing the connection between the lens port and housing may be used. In use an object 4 will be the subject that it is intended to photograph. The object 4 is underwater being immersed in water 5. The macro conversion lens 1 comprises a lens assembly having in sequence, by reference to the object, a first lens element 10, a second lens element 11 and a third lens element 12.

The macro conversion lens 1 sits, in use, in front of the lens port window 13. In use, also the space between the third lens element 12 and the lens port window 13 will be filled with water 14. Because the lens elements 10, 11 and 12 are sealed to the barrel 15 of the macro conversion lens 1 no water is present between the lens elements 10 and 11 and the lens elements 11 and 12. The conversion lens 1 may be attached to the front of the lens port 2 in any suitable manner, for example, by mutual screw threads.

The basic construction of the conversion lens according to the present invention comprises, in succession from the object 4, the first lens element 10 which has an overall positive refractive power. This may be achieved by forming the first lens element 10 by a cemented lens element consisting of a negative meniscus lens 20 and a bi-convex lens 21. The second lens element 11 consists of a meniscus lens with the convex surface 22 facing towards the object 4 and therefore the lens element 10. The third lens element 12 also consists of a meniscus lens with its convex surface 23 facing the object 4 and therefore also the lens elements 10 and 11.

I am not aware of a formula to derive the magnification, which is empirically derived.

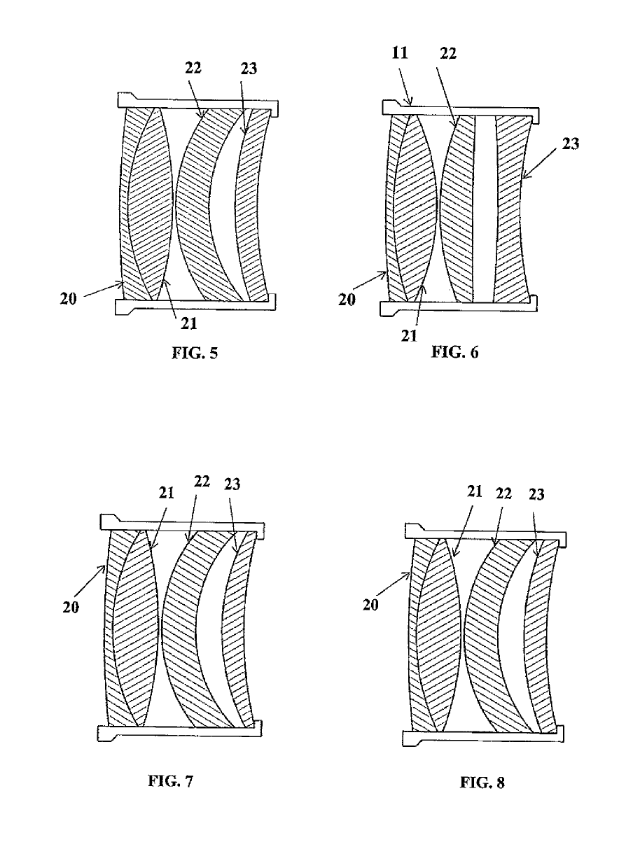

FIG. 5 above shows a first preferred embodiment of the present invention. The macro conversion lens is formed as above described with reference to FIG. 4. Various elements in the design value of the underwater macro conversion lens according to the first embodiment are shown in table 1 below:

TABLE 1

| Rᵢ | rᵢ | dᵢ | vᵢ | nᵢ | |
|---|---|---|---|---|---|
| | (Seawater) | | 57.918 | 1.339 | |
| R₁ | 261.385 | 2.5 | 23.827 | 1.846 | |
| R₂ | 60.004 | 14 | 49.59 | 1.772 | |
| R₃ | −103.077 | 1 | | | |
| R₄ | 50.006 | 10.5 | 46.568 | 1.804 | |
| R₅ | 45.517 | 8.2 | | | |
| R₆ | 88.233 | 7 | 49.59 | 1.772 | |
| R₇ | 108.597 | 10 | 57.918 | 1.339 | (Seawater) |

Rᵢ represents each lens surface,
rᵢ represents the radius of curvature of the lens surface in mm,
dᵢ represents the surface spacing on the optical axis between the lens surface Rᵢ and the lens surface Rᵢ₊₁ in mm.
nᵢ represents the refractive index of the medium between the lens surface Rᵢ and the lens surface Rᵢ₊₁ for d-ray (λ = 587.6 nm), and
vᵢ represents the Abbe number (which relates to the dispersion) of the medium between the lens surface Rᵢ and the lens surface R_{i+1.}

I believe the radius of curvature, abbe number and refractive index can be computer generated, for example, by specifying the number of lenses and the characteristics of at least one lens.

In practice it is found that the effect of the water, in this case designated seawater, has been taken into account. The characteristics of at least one lens element, such as the radius of curvature of surface 23 has been selected to take the effects of the water into account. The characteristics of this surface are compensated for in the characteristics of the other lens elements if required.

FIG. 6 shows a second preferred embodiment of the present invention. Various elements in the design value of the underwater macro conversion lens according to the second embodiment are shown in table 2 below:

TABLE 2

| Rᵢ | rᵢ | dᵢ | vᵢ | nᵢ | |
|---|---|---|---|---|---|
| | (Seawater) | | 57.918 | 1.339 | |
| R₁ | 265.011 | 2.5 | 23.827 | 1.846 | |
| R₂ | 91.212 | 14 | 53.134 | 1.622 | |
| R₃ | −68.821 | 1 | | | |
| R₄ | 76.772 | 10.5 | 54.657 | 1.664 | |
| R₅ | 855.575 | 8.2 | | | |
| R₆ | −407.341 | 7 | 31.384 | 1.689 | |
| R₇ | 117.603 | 10 | 57.918 | 1.339 | (Seawater) |

In this construction the surface 23 which is convex with respect to the lens element 11 is formed by the surface 23 of the lens element 12 which is physically furthest from the lens element 10.

FIG. 7 above shows a third preferred embodiment of the present invention. Various elements in the design value of the underwater macro conversion lens according to the third embodiment are shown in table 3 below:

TABLE 3

| Rᵢ | rᵢ | dᵢ | vᵢ | nᵢ | |
|---|---|---|---|---|---|
| | (Seawater) | | 57.918 | 1.339 | |
| R₁ | 265.321 | 2.5 | 23.827 | 1.846 | |
| R₂ | 58.641 | 14 | 53.868 | 1.713 | |
| R₃ | −108.127 | 1 | | | |
| R₄ | 46.703 | 10.5 | 47.902 | 1.717 | |
| R₅ | 41.987 | 8.2 | | | |
| R₆ | 61.543 | 7 | 55.521 | 1.697 | |
| R₇ | 117.614 | 10 | 57.918 | 1.339 | (Seawater) |

FIG. 8 above shows a fourth preferred embodiment of the present invention. Various elements in the design value of the underwater macro conversion lens according to the fourth embodiment are shown in table 4 below:

TABLE 4

| Rᵢ | rᵢ | dᵢ | vᵢ | nᵢ | |
|---|---|---|---|---|---|
| | (Seawater) | | 57.918 | 1.339 | |
| R₁ | 257.983 | 2.5 | 23.827 | 1.846 | |
| R₂ | 66.948 | 14 | 55.519 | 1.678 | |
| R₃ | -85.994 | 1 | | | |
| R₄ | 46.703 | 10.5 | 46.212 | 1.608 | |
| R₅ | 44.592 | 8.2 | | | |
| R₆ | 78.325 | 7 | 49.59 | 1.772 | |
| R₇ | 117.618 | 10 | 57.918 | 1.339 | (Seawater) |

The above examples have been found useful but are not exhaustive of the invention.

### INDUSTRIAL APPLICABILITY

In use the conversion lens is attached to the lens port and underwater photography can be performed as desired. The conversion lens can be removed from the lens port and replaced if desired.

### Advantages

The conversion lens of the invention has been designed for underwater use by taking into account the refractive index of seawater to maximize magnification and optical performance, and also to provide an ample working distance between the photographer and the object.

### Variations

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

What we claim is:

1. A macro conversion lens including a sequential assembly of lens elements, the sequence including a first lens element, a second lens element and a third lens element, wherein the second lens element is positioned between the first and third lens elements, each lens element being substantially co-axial and the second lens element comprising a meniscus lens convex with respect to the first lens element.

2. A macro conversion lens as claimed in claim 1 wherein the first lens element has a positive refractive power.

3. A macro conversion lens as claimed in claim 1 wherein the third lens element has a surface convex with respect to the first lens element.

4. A macro conversion lens as claimed in claim 1 wherein the characteristics of at least one lens element is selected to compensate for the use of the conversion lens in water.

5. A macro conversion lens as claimed in claim 1 wherein the first lens element comprises a first part being a meniscus lens and a second part being a bi-convex lens.

6. A macro conversion lens as claimed in claim 5 wherein the meniscus lens is a negative meniscus lens.

7. A macro conversion lens as claimed in claim 5 wherein the first part and second part of the first lens element comprise a cemented lens element.

8. A macro conversion lens according to claim 1 mounted on an underwater lens port.

9. A macro conversion lens according to claim 2 mounted on an underwater lens port.

10. A macro conversion lens according to claim 3 mounted on an underwater lens port.

11. A macro conversion lens according to claim 4 mounted on an underwater lens port.

12. A macro conversion lens according to claim 5 mounted on an underwater lens port.

13. A macro conversion lens according to claim 6 mounted on an underwater lens port.

14. A macro conversion lens according to claim 7 mounted on an underwater lens port.
